(19) United States
(12) Patent Application Publication
(10) Pub. No.: US 2009/0042023 A1
(43) Pub. Date: Feb. 12, 2009

(54) Heat-Sealable Bi-Oriented Polypropylene Film, Use of this Film and an Article Prepared from Said Film

(76) Inventors: Aldo Arruda Mortara, Sorocaba (BR); Rosicarla Vectirans Vieira, Votorantim (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/722,943

(22) PCT Filed: Dec. 27, 2005
(86) PCT No.: PCT/BR05/00260

§ 371 Date: Apr. 7, 2008

(30) Foreign Application Priority Data
Dec. 27, 2004 (BR) PI0405944-1
Dec. 20, 2005 (BR) PI0506174-1

(51) Int. Cl. B32B 27/32; B32B 5/00

(52) U.S. Cl. 428/336; 428/516

(57) ABSTRACT

The present invention relates to a bi-oriented polypropylene film comprising a polypropylene homopolymer base layer and at least one adjacent heat sealable polymeric layer, which in turn is constituted of a hydrocarbonic resin and a polymeric material. This film is used for making packages for paper reams, foods-tuffs, perfumery among other packages, since it exhibits ideal properties to ensure adequate closure and airtightness thereof. Thus, it protects the packed product against the action, for example, of moisture and dust.

This application claims priority of Brazilian patent application filed on Dec. 20, 2004 which claims priority of Brazilian patent application number PI 0405944-1 filed on Dec. 27, 2004, the disclosure thereof being hereby incorporated by reference.

### FIELD OF THE INVENTION

The present invention relates to a bi-oriented polypropylene film comprising a polypropylene base layer and at least one heat-sealable polymeric layer. This film is preferably used for making packages for paper reams, since it has ideal sealing and slipping properties, so as to guarantee adequate closing and airtightness thereof. Alternatively, this film may also be used for packing food products, perfumery, among other packages.

### DESCRIPTION OF THE PRIOR ART

At present, the polymeric packages used for packing reams are shaped and their ends are closed with hot glue. This process is called “hot-melt” closing. In summary, by this process the polymeric package is shaped to receive the ream, and its ends are joined by means of hot glue. In this case, there is an additional cost due to the fact that this second material is compulsorily used in order to provide said package, besides having a few drawbacks:
the package opens easily due to the points of the ends where the glue has not been adequately applied. Consequently, airtightness is lost, which may cause damage to the packed product due to moisture, dust, etc., and
the glue has the disadvantage that it may dirty the sheets of paper when it flows into the package. This contamination, besides impairing the visual aspect of the product, may cause damage to the photocopying machines, since the glue that remains impregnated in the paper comes in contact with the cylinders, damaging them.

In order to eliminate these drawbacks, some polymeric films have been developed, especially olefins, which have the heat sealing property.

The applicant indicates, hereinafter, the relevant document of the prior art related to the matter of the present invention.

Document U.S. Pat. No. 5,900,310 discloses an oriented multi-layer polyolefin film, by preference biaxially oriented and heat-sealable, which comprises a polypropylene base layer and an outer layer on each side of the base layer. These outer layers contain copolymers and/or terpolymers of propylene and further a mixture of antiblocking agent, the particles of which have a diameter ranging from 3 to 5 μm and of 1 to 2.5 μm. The outer layers further may comprise some neutralizing, antistatic and stabilizing agents.

On the other hand, document U.S. Pat. No. 4,842,930 describes a multi-layer film, at least monoaxially oriented, heat-sealable, which comprises a polypropylene base layer and at least one heat-sealable outer layer consisting of polymers such as propylene terpolymer, butene-1 and ethylene or ethylene copolymer and butene-1 in specific amounts. It may further contain additives as opacifying, antiblocking, stabilizing, lubricating additives, among others.

Further, document U.S. Pat. No. 5,254,393 relates to a film of transparent, co-extruded, multilayer polyolefin, heat-sealable on both sides and comprising a base layer consisting of peroxydically degraded polypropylene and outer layers of heat-sealable ethylene-propylene polymers.

And document WO 03/93355 describes a transparent, coated heat-sealable film comprising a substrate of blend of biaxially-oriented polypropylene and a water-based coating. The substrate may also comprise other layers of propylene-ethylene-butylene terpolymer.

From the description of the present invention hereinafter, one can conclude that no teaching of the prior art proposes advantages relating to the physicochemical properties and financial expenditures foreseen in the present invention, presented hereinafter.

### SUMMARY OF THE INVENTION

An objective of the invention is to provide a bi-oriented polypropylene film comprising a polypropylene homopolymer base layer and at least one heat sealable polymeric layer adjacent the base layer, which is constituted by at least polypropylene termpolymer/ethene/butene/and a hydrocarbonic resin.

The invention further discloses the application of said bi-oriented polypropylene film in the preparation of articles, as well as the thus obtained article.

### DETAILED DESCRIPTION OF THE INVENTION

The present invention discloses a bi-oriented polypropylene film comprising:
(i) a polypropylene homopolymer base layer and
(ii) at least one heat sealable polymeric layer,

wherein said heat sealable polymeric layer comprises at least one hydrocarbonic resin and a polymeric material selected from polypropylene terpolymer/ethene/butene, polypropylene copolymer/ethene, polypropylene copolymer/butene, ethene copolymer/butene, polybutene and combinations thereof.

The invention further discloses the application of said bi-oriented polypropylene film in the preparation of articles. The proportions of the components involved will be further defined later.

The present invention has a number of advantages over the compositions of the prior art, among which the following are pointed out:
the package that comprises the film of the present invention has better airtightness as compared with the hot-melt closed package;
with the present invention, one prevents the drawback of dirtying the sheets of paper that are packed in the package comprising the polypropylene film of the present invention, since one does not use glue or any similar component for closing the package. Therefore, the quality and appearance of the product packed in this package are preserved;
the present invention confers a differentiated aspect to the package, since it has a smooth and uniform aspect thanks to the fact that no glue is used;
this is an economical product, since it is not necessary to use a closing process like the “hot-melt” one in conjunction with the low cost of the components used in the film of the present invention, which makes it cheaper, for example, than the films made by “UCB”. Therefore, there is a reduction of the production costs;
the film of the present invention has optimum slip properties;
packages completed with the hot-melt closing may open more easily; on the other hand, the closing through the heat sealing of the film of the present invention prevents this drawback; and
due to the presence of hydrocarbonic resin in the heat sealable polymeric layer, the film has higher optical quality, greater resistance to abrasion, greater rigidity and greater hardness when compared with other bi-oriented polypropylene films known at present.

The layers that constitute the film of the present invention and the components that may be used in the formulation of said layers are described hereinafter.

### Polypropylene Base Layer

The polypropylene base layer is essentially built with polypropylene homopolymer. This polypropylene is preferably selected from the types: standard and high crystallinity.

In addition to the presence of homopolymer, one uses additives to provide characteristics and/or properties that are not achieved with the use of polymer alone. One may add additives commonly found in polymeric compositions of the prior art. Preferably, the following are added:
antistatic additive such as ethoxylated tertiary amine, diethoxylamine, esterified ethoxylamione and monosteryl glycerate;
optionally, opacifying additive (evidently this additive is only added to the composition of the base layer if one desires that it becomes opaque. In the absence of this additive, the base layer will be transparent): carbonates and titanium dioxide.

In order to obtain preferred embodiments of the film of the present invention, said film being transparent, one adds the following to the polypropylene base layer:
an amount of polypropylene homopolymer raging from about 70% to about 100% by weight, preferably from 99.7% to 100% by weight, and more preferably about 99.7% by weigh;
an amount of antistatic additive ranging from about 0% to about 10% by weight, preferably from 0 to 1% by weight, and more preferably about 0.3% by weight;
based on the total weight of the polypropylene base layer.

On the other hand, in order to achieve preferred variations of the film of the present invention, the film being opaque, one adds to the polypropylene base layer:
an amount of polypropylene homopolymer ranging from about 70% to about 95% by weight, preferably from 70% to 96% by weight, and more preferably about 91.7% by weight;
an amount of antistatic additive ranging from 0% to about 10% by weight, preferably from 0 to 1% by weight, and more preferably about 0.3% by weight;
an amount of opacifying additive ranging from about 4% to about 20% by weight, preferably about 8% by weight;
based on the total weight of the polypropylene base layer.

### Heat Sealable Polymeric Layer

Preferably, the thickness of this layer, also called cover, ranges from about 0.8 to 2.0 μm, preferably from 1.0 μm to 1.4 μm. This layer is adjacent the base layer.

In this layer present in the film of the present invention, one may use at least one polymeric material selected from polypropylene terpolymer/ethene/butene/polypropylene copolymer/ethene/polypropylene copolymer/butene, ethene copolymer/butene, polybutene and combinations thereof.

In addition to the polymeric material selected from the above options, one uses additives so as to provide characteristics and/or properties that are not achieved with the use of polymer alone. One may use additives commonly found in polymeric compositions of the prior art, preferably, the following ones:
antiblocking agent such as organic and inorganic fine particles. Examples of organic particles indicated for use as antiblocking additives are: polyethylene, polyamides, polyesters, polyacrylic acid esters, polymetacrylic acid esters, among others Further, examples of inorganic particles indicated for use as antiblocking additives are: talc, kaolin, silica or calcium carbonate, glass powder, among others.
Slip additives such as erucamide, oleamide, stearamide, ethylene bistearamide, polydimethylsyloxane, syloxane, silicone, ethylene bisoleamide, stearyl erucamide, oleyl palmitamide and other saturated fatty amides, unsaturated fatty amides.
At least one hydrocarbonic resin such as petroleum resins, styrene resins, cyclopentadiene resins terpene resins, styrene homopolymers, styrene copolymers, styrene methyl, vinyl toluene, indene, among others.

In preferred embodiments, the heat sealable polymeric layer comprises:
an amount of polypropylene terpolymer/ethene/butene ranging from about 40.0% to about 80.0% by weight, preferably ranging from 73% to 98% by weight, and more preferably about 79.7% by weight;
an amount of hidrocarbonic resin which ranges from about 2% to about 25% by weight, preferably ranging about 20% by weight;
an amount of antiblocking additive ranging from 0% to about 6% by weight, preferably from 0 to 1% by weight, and more preferably about 0.2% by weight;
an amount of slip additive ranging from about 0% to about 6.0% by weight, preferably ranging from 0 to 1% by weight, and more preferably about 0.1% by weight,

all the above amounts being based on the total weight of the composition of the heat sealable polymeric layer.

The presence of the hydocarbonic resin in the heat sealable polymeric layer is essential to the present invention, since it confers to the film film higher optical quality, greater resistance to abrasion, greater rigidity and greater hardness.

There are documents of the prior art, for example, U.S. Pat. No. 6,777,067, which describe bi-oriented polypropylene films containing hydrocarbonic resin. However, today it is known to use this type of resin in the base layers of the film, wherein homopolymer, in this case, polypropylene, is found. The present invention provides the use of this resin in the heat sealable layer. Thus, the film exhibits the physicochemical properties listed above, without the need to make great expenditures to achieve this objective. The presence of the resin in the base layer, for example, does not confer to the film the advantages listed above.

### Optional Components for the Layers Present in the Film of the Present Invention

In order to confer to the composition of the layers of the film of the present invention some desirable characteristic, one may further add optional formulation-auxiliary components that have physicochemical properties compatible with the properties thereof. One may add components that are usually added to compositions of polypropylene films.

### Heat Sealable Polypropylene Film

The film of the present invention comprises at least one polypropylene base layer and a heat sealable polymeric layer, adjacent as already defined. In alternative embodiments, one may add to these layers other layers already known from the prior art, in an alternate/intercalated manner, as for example, layers treated for receiving graphic printing.

Preferably, the film of the present invention comprises two polypropylene base layers and two heat sealable polymeric layers; said base layers being transparent or one being transparent and the other opaque, or both being opaque and said heat sealable layers being transparent.

### Process of Preparing Said Film

The process of making the film of the present invention is commonly known. In summary, the process of making the film in question comprises the following steps:
1—extrusion, wherein the melting of the polypropylene occurs, which is then expelled from a flat die in the form of molten PP (polypropylene);
2—casting, wherein the formation and cooling of the polypropylene film occurs;
3—longitudinal stretching, which promotes, by mechanical stretching, the orientation of the polypropylene chains of the film in the longitudinal direction;
4—transverse stretching, which, like the preceding step, provides orientation by means of mechanical stretching, but this time in the transverse direction, thus resulting in a biaxially oriented polypropylene film;
5—traction and treatment or the oriented film; and
6—winding.

The polypropylene used in step 1 of the above process is obtained by polymerizing propene, which is a product derived from the cracking of naphtha and may be of either of the Standard type or by the high-crystallinity type.

The heat sealable layer may be introduced in the process preferably in steps 1 to 3.

Further, a thin layer of sealing polymer is applied, during the manufacturing process itself, onto at least one of the faces of the polypropylene homopolymer base layer by a separate conversion process. This polymer is preferably one of those already cited.

In this regard, in the present invention there is no need for an additional operation for application of a sealable coating. Therefore, the film of the present invention is a multi-layer film comprising at least one polypropylene base layer and at least one layer with the heat sealing characteristic, adjacent each other, wherein the latter layer normally receives a surface treatment necessary for the conversion process.

With the completed film, one already may start the step of forming the package. The equipment used for packing, preferably reams of paper, is similar to those already known for this purpose, only having an additional means (belts with temperature and pressure) specific for providing the aimed-at heat sealable.

### SPECIFIC EXAMPLES OF COMPOSITIONS OF THE FILM OF THE PRESENT INVENTION

The illustrative examples presented hereinafter will serve to describe better the present invention, the values indicating the weight percentage of each phase in the final product.

However, the illustrated data merely refer to some embodiments of the present invention and should not be taken as limitative of the scope of the invention. The scope of the present invention embraces other possible variations, being limited only by the contents of the accompanying claims, which include the possible equivalents.

### Example 1

### Transparent Bi-oriented Polypropylene Film

A film comprising three ABA-type layers, wherein A is the outer layer called heat sealable polymeric layer and B is the core layer called polypropylene homopolymer base layer, was produced by extrusion and then stretched in the longitudinal and transverse directions.

The polypropylene base layer comprises 100% of Standard polypropylene homopolymer. On the other hand, the heat sealable outer layers comprise 79.15% of polypropylene terpolymer/ethene/butene, 0.15% of polyacrylic acid ether acting as an antiblocking additive, 0.7% of polymethylsyloxane being slip additive and 20% of hydrocarbonic resin.

### Example 2

### Opaque Bi-oriented Polypropylene Film

A polypropylene film comprising three ABA type layers, wherein A is the outer layer (heat sealable polymeric layer) and B is the core layer (polypropylene homopolymer base layer) was produced according to the same procedure of Example 1: extrusion of the film and then stretching it in the longitudinal and transverse directions.

The polypropylene base layer comprises 90.36% of Standard polypropylene homopolymer, 0.5% of ethoxylated tertiary amine as antistatic additive and 10% of calcium carbonate as opacifying additive.

The heat sealable outer layers comprise 75.6% of polypropylene terpolymer/ethene/butene, 0.12% of polyacrylic acid ether acting as antiblocking additive, 0.12% of polymethylsyloxane being slip additive and 19.4% of hydrocarbonic resin.

### Tests for Performance of the Film of the Present Invention

A few packing tests were made so as to prove the efficacy of the heat sealing conferred to the film of the present invention:

1) Heat Sealing with Composite Structure of the Films Described in the Above Examples Being Laminated with Photocell Pass:

This test was carried out with the packing process at a speed of up to 85 packages/min, under a sealing temperature of 135° C. for the sides and a sealing temperature ranging from 137° C. to 139° C. for the package bottom.

At the maximum speed of 85 packages per minute, the sealing was uniform, with optimum resistance and without the sealed area wrinkling. On the basis of these results, some packages were made at the speed of about 100 packages/min without sealing problems.

One has observed that the sealing at the sides of the package exhibited high bond strength.

### 2) Test for Abrasion Strength 01

The abrasion strength of a film may be measured subjectively either by visual comparison or quantitatively form comparing the Haze measures, before and after the film passing through a friction-coefficient measuring apparatus (TMI), simulating the abrasion caused, for instance, by stacking packages of reams.

The results obtained for the film of the present invention in the transparent embodiment, by using the quantitative method described above, the formulation of which is the same as in Example 1 mentioned above, with various cover thicknesses, are presented in the table below, in comparison with a similar film illustrated in example 1 without containing hydrocarbonic resin.

TABLE 1
Test for Abrasion Simulated on the TMI

| | Cover | Haze | | Reduction in the |
|---|---|---|---|---|
| | thickness | measurements | | measurements |
| Film | (μm) | Before | After | (%) |
| Film without hydro- | 1.8 | 2.2 | 6.56 | 198.2 |
| carbonic resin | | | | |
| Film of the present | | 1.85 | 2.07 | 11.9 |
| invention | | | | |
| Film without hydro- | 1.0 | 1.25 | 1.60 | 28.0 |
| carbonic resin | | | | |
| Film of the present | | 0.96 | 1.05 | 9.4 |
| invention | | | | |

One can see that the Haze values obtained for the film of the present invention exhibit a difference of 11.9%, based on the value prior to the simulation of friction. On the other hand, the value obtained for the film without hydrocarbonic resin in the composition of the heat sealable layer of the polymeric film is 3 times higher than the initial value. Therefore, one concludes that the film of the present invention exhibits a higher resistance to abrasion significantly in comparison with a film of the prior art.

In addition, one can prove that the abrasion strength improves significantly with a reduction of the cover thickness.

### 3) Test for Abrasion Strength 02

An important characteristic to be pointed out is that the slip agent polydimethylsyloxane is known from the prior art for conferring abrasion strength to polymeric films. However, as can be seen from the result of the test described below, this chemical compound does not provide such a quality to the film of the present invention, the abrasion-strength property being achieved with the presence of hydrocarbonic resin in the heat sealable layer.

Thus, in order to exclude the interference of the polydimethylsyloxane compound with respect to the hydrocarbonic resin, tests were carried out, wherein the results of the films with the ingredient mentioned was evaluated.

| | | | | Reduction |
|---|---|---|---|---|
| | | Haze | | in the |
| | Cover | measurement | | measure- |
| Film | thickness | Before | After | ments |
| Film with hydrocarbonic res- | 1.0 | 0.96 | 1.02 | 6.25% |
| in and without polydimeth- | | | | |
| ylsyloxane | | | | |
| Film with hydrocarbonic res- | | 0.84 | 0.94 | 11.9% |
| in and polydimethylsiloxane | | | | |

As can be seen, the results above show that the presence of the slip agent does not influence the abrasion-strength characteristic.

1. A bi-oriented polypropylene film comprising:
(i) a polypropylene homopolymer base layer and
(ii) at least one heat sealable polymeric layer adjacent to the base layer,
said film being characterized in that said heat sealable polymeric layer comprises at least one hydrocarbonic resin and a polymeric material selected from polypropylene terpolymer/ethene/butene, polypropylene copolymer/ethene, polypropylene copolymer/butene, ethene copolymer/butene, polybutene and combinations thereof.

2. A bi-oriented polypropylene film according to claim 1, characterized in that the amount of hydrocarbonic resin present in the heat sealable polymeric layer ranges from 2% to 25% by weight, based on the total weight of the composition of said heat sealable polymeric layer.

3. A bi-oriented polypropylene film according to claim 2, characterized in that the amount of hydrocarbonic resin present in the heat sealable polymeric layer is of about 20% by weight, based on the total weight of the composition of said heat sealable polymeric layer.

4. A bi-oriented polypropylene film according to claim 1, characterized in that the amount of polypropylene homopolymer present in the base layer ranges from 99% to 100% by weight, based on the total weight of the composition of said base layer.

5. A bi-oriented polypropylene film according to claim 4, characterized in that the amount of polypropylene homopolymer amount present in the base layer is of about 99.7% by weight, based on the total weight of the composition of said base layer.

6. A bi-oriented polymeric film according to claim 1, characterized in that the polypropylene base layer comprises at least one antistatic additive selected from the group consisting of ethoxylated tertiary amine, diethoxylamine, esterified ethoxylamine and monoesteryl glycerate, variations and combinations thereof.

7. A bi-oriented polypropylene film according to claim 6, characterized in that the polypropylene homopolymer base layer comprises an amount of antistatic additive of up to 1% by weight, based on the total weight of the composition of said base layer.

8. A bi-oriented polypropylene film according to claim 1, characterized in that the polypropylene homopolymer base layer comprises at least one opacifying additive selected from carbonates and titanium dioxide.

9. A bi-oriented polypropylene film according to claim 8, characterized in that the amount of opacifying additive in the composition of the polypropylene homopolymer base layer ranges from 4% to 20% by weight, based on the total weight of the composition of said base layer.

10. A bi-oriented polypropylene film according to claim 8, characterized in that the opacifying additive is calcium carbonate.

11. A bi-oriented polypropylene film according to claim 8, characterized in that the amount of polypropylene homopolymer present in the base layer ranges from 79% to 96% by weight, based on the total weight of said base layer.

12. A bi-oriented polypropylene film according to claim 11, characterized in that the amount of polypropylene homopolymer present in the base layer is of about 91.7% by weight, based on the total weight of the composition of said base layer.

13. A bi-oriented polypropylene film according to claim 1, characterized in that the heat sealable polymeric layer comprises polypropylene terpolymer/ethene/butene in an amount ranging from 73.0% to 98.0% by weight, based on the total weight of the composition of said heat sealable polymeric layer.

14. A bi-oriented polypropylene film according to claim 13, characterized in that the amount of polypropylene terpolymer/ethene/butene present in the composition of said heat sealable polymeric layer is of about 79.7% by weight, based on the total weight of the composition of said heat sealable polymeric layer.

15. A bi-oriented polypropylene film according to claim 1, characterized in that the heat sealable polymeric layer comprises an antiblocking additive selected from the group consisting of organic particles such as polyethylene, polyamides, polyester, polyacrylic acid esters, polymetacrylic acid esters; inorganic particles such as talc, kaolin, silica, calcium carbonate, glass powder, variations and combinations thereof.

16. A bi-oriented polypropylene film according to claim 14, characterized in that the amount of antiblocking additive present in the composition of the heat sealable layer is of up to 1% by weight, based on the total weight of the composition of said heat sealable polymeric layer.

17. A bi-oriented polypropylene film according to claim 15, characterized in that the antiblocking additive present in the composition of the polymeric layer is polyacrylic acid ether.

18. A bi-oriented polypropylene film according to claim 1, characterized in that the heat sealable polymeric layer comprises a slip additive selected from the group consisting of erucamide, ethylene bisoleamide, stearyl erucamide, oleyl palmitamide and other saturated fatty amides, unsaturated fatty amides and combinations thereof.

19. A bi-oriented polypropylene film according to claim 18, characterized in that the amount of slip additive present in the composition of the heat sealable polymeric layer is of up to 1% by weight, based on the total weight of the composition of said heat sealable polymeric layer.

20. A bi-oriented polypropylene film according to claim 1, characterized in that the heat sealable polymeric layer comprises a slip additive wherein the slip additive is polydimethylsyloxane.

21. A bi-oriented polypropylene film according to claim 1, characterized in that the thickness of the heat sealable polymeric layer ranges from 0.8 to 2.0 μm.

22. A bi-oriented polypropylene film according to claim 21, characterized in that the thickness of the heat sealable polymeric layer ranges from 1.0 μm to 1.4 μm.

23. Use of at least one bi-oriented polypropylene film as defined in claim 1, characterized in that it is for the production of articles.

24. An article characterized by comprising a bi-oriented polypropylene film as defined in claim 1.

25. An article according to claim 24, characterized in that it is a package for packing paper ream.

26. A bi-oriented polypropylene film according to claim 1, wherein the polypropylene homopolymer base layer is free of hydrocarbonic resin.
